(19) United States
(12) Patent Application Publication
(10) Pub. No.: US 2022/0381081 A1
(43) Pub. Date: Dec. 1, 2022

(54) MOBILE BODY CONTROL SYSTEM, MOBILE BODY CONTROL METHOD, AND RECORDING MEDIUM

(71) Applicant: HONDA MOTOR CO., LTD., Tokyo (JP)

(72) Inventors: Mizuki Katsu, Tokyo (JP); Naoki Shibata, Tokyo (JP); Atsushi Sekiguchi, Tokyo (JP); Shigeki Takahashi, Tokyo (JP); Tomohiro Suzuki, Tokyo (JP); Takamune Tsukahara, Tokyo (JP); Kenichiro Kagawa, Tokyo (JP); Futoshi Kobayashi, Tokyo (JP); Masayuki Watarai, Tokyo (JP); Makoto Ono, Tokyo (JP); Katsuyasu Yamane, Tokyo (JP); Koji Hashimoto, Tokyo (JP); Hironori Takano, Tokyo (JP)

(21) Appl. No.: 17/827,009

(22) Filed: May 27, 2022

(30) Foreign Application Priority Data
May 31, 2021 (JP) 2021-091088

(51) Int. Cl. E05F 15/70; B60R 16/037

(52) U.S. Cl. CPC E05F 15/70; B60R 16/0373; E05Y 2400/42; E05Y 2400/45; E05Y 2400/85; E05Y 2900/55

(57) ABSTRACT

A mobile body control system includes: a window open or close instruction recognition unit that recognizes an open or close instruction of a window provided to a mobile body in accordance with a voice operation or an operation of a mobile terminal performed by a passenger on the mobile body; a window control unit that executes a window open or close control for opening or closing the window, when the open or close instruction of the window is recognized; and a window operation restriction unit that executes at least one of window operation inhibition processing for inhibiting execution of the window open or close control by the window control unit in accordance with an operation of a switch provided to the mobile body, and window operation stop processing for stopping the window being operated by the window open or close control in accordance with an operation of the switch.

### INCORPORATION BY REFERENCE

The present application claims priority under 35 U.S.C. § 119 to Japanese Patent Application No. 2021-091088 filed on May 31, 2021. The content of the application is incorporated herein by reference in its entirety.

### BACKGROUND OF THE INVENTION

### Field of the Invention

The present invention relates to a mobile body control system, a mobile body control method, and a recording medium.

### Description of the Related Art

Conventionally, a vehicle is provided with switches for opening or closing windows thereof, and it is possible to open or close the windows of the seats (front seat, rear seats) other than the driver seat by operating the switches provided individually at the door of each of the seats or the switch provided at the door of the driver seat. Therefore, the passengers sitting on the rear seats cannot open or close the windows of the other seats such as the driver seat, for example.

Furthermore, there is proposed a configuration with which windows of a vehicle are opened or closed in accordance with an open or close instruction of the windows by vocalization of the passenger of the vehicle (for example, see Japanese Patent Laid-Open No. 2020-157808).

As described above, in a case where open or close operations of the windows in a mobile body such as a vehicle are made possible via vocalization, for example, the passenger on the rear seat can cause the windows of other seats to move than the seat where the passenger oneself is seated by speaking “open the window of the driver seat”. In such a case, the window of the driver seat may be opened against the intention of the driver.

The present invention is designed in view of the foregoing circumstances, and it is an object thereof to provide a vehicle control system, a vehicle control method, and a recording medium comprising a vehicle control program for preventing the windows from being opened or closed against the intention of passengers when a plurality of passengers are on a mobile body.

### SUMMARY OF THE INVENTION

Aa a first aspect for implementing the foregoing object, there may be a mobile body control system including: a window open or close instruction recognition unit that recognizes an open or close instruction of a window provided to a mobile body in accordance with a voice operation or an operation of a mobile terminal performed by a passenger on the mobile body; a window control unit that executes a window open or close control for opening or closing the window according to the instruction, when the open or close instruction of the window is recognized by the window open or close instruction recognition unit; and a window operation restriction unit that executes at least one of window operation inhibition processing for inhibiting execution of the window open or close control by the window control unit in accordance with an operation of a switch provided to the mobile body, and window operation stop processing for stopping the window that is being operated by the window open or close control in accordance with an operation of the switch.

In the mobile body control system, the switch is a window lock switch for inhibiting an open or close operation of the window, and the window operation restriction unit may execute the window operation inhibition processing, when turned into a window lock state where the open or close operation of the window is inhibited by an operation of the window lock switch.

The mobile body control system may include a window operation restriction notification unit that notifies, by a notification unit provided to the mobile body, that the open or close operation of the window is inhibited, when the open or close instruction of the window is recognized by the window open or close instruction recognition unit in the window lock state.

In the mobile body control system, the mobile body has, as the window, a driver seat window corresponding to a driver seat and another seat window corresponding to another seat other than the driver seat. The mobile body further includes: a driver seat window switch for giving an instruction to open or close the driver seat window; and another seat window switch for giving an instruction to open or close the another seat window. In the window lock state, the window control unit may: inhibit accepting the instruction to open or close the another seat window by an operation of the another seat window switch; and accept the instruction to open or close the driver seat window by an operation of the driver seat window switch.

The mobile body control system includes: a first control device and a second control device communicating mutually; a switch operation state recognition unit that is provided to the first control device and recognizes an operation state of the window lock switch; and a window lock information saving unit that, upon recognizing by the switch operation state recognition unit through having communication between the first control device and the second control device that a setting operation of the window lock state is performed via the window lock switch, saves window lock information indicating as being in the window lock state to a storage unit that is provided to the second control device. The window operation restriction unit may refer to the window lock information saved in the storage unit to recognize as being in the window lock state.

The mobile body control system may include a voice recognition unit that executes recognition processing of the voice operation, after recognizing a voice of a prescribed wakeup word.

In the mobile body control system, when the window is being operated by the window open or close control, the window operation restriction unit may execute the window operation stop processing when a stop button displayed on a touch panel provided to the mobile body or an open or close switch of the window provided to the mobile body is operated as the operation of the switch.

In the mobile body control system, the mobile body includes a plurality of the windows of different kinds, and the window operation restriction unit may set the window to be an execution target of the window operation inhibition processing in accordance with the kinds of the windows.

As a second aspect for implementing the foregoing object, there may be a mobile body control method executed by a computer, and the method includes: a window open or close instruction recognition step of recognizing an open or close instruction of a window provided to a mobile body in accordance with a voice operation or an operation of a mobile terminal performed by a passenger on the mobile body; a window control step of executing a window open or close control for opening or closing the window according to the instruction, when the open or close instruction of the window is recognized by the window open or close instruction recognition step; and a window operation restriction step of executing at least one of window operation inhibition processing for inhibiting execution of the window open or close control performed by the window control step in accordance with an operation of a switch provided to the mobile body, and window operation stop processing for stopping the window that is being operated by the window open or close control in accordance with an operation of the switch.

As a third aspect for implementing the foregoing object, there may be a non-transitory computer readable recording medium comprising a mobile body control program to be executed by a processor of a computer provided to a mobile body control system for controlling a mobile body, wherein the processor executes the mobile body control program to: recognize an open or close instruction of a window provided to the mobile body in accordance with a voice operation or an operation of a mobile terminal performed by a passenger on the mobile body; execute a window open or close control for opening or closing the window according to the instruction, when the open or close instruction of the window is recognized; and execute at least one of window operation inhibition processing for inhibiting execution of the window open or close control in accordance with an operation of a switch provided to the mobile body, and window operation stop processing for stopping the window that is being operated by the window open or close control in accordance with an operation of the switch.

According to the mobile body control system, it is possible to prevent the windows from being opened or closed against the intention of passengers when a plurality of passengers are on a vehicle, by executing at least one of the window operation inhibition processing that inhibits execution of the window open or close control and the window operation stop processing that stops the window being operated by the window open or close control in accordance with the operation of the switch provided to the mobile body.

### BRIEF DESCRIPTION OF THE DRAWINGS

FIG. 1 is a block diagram of a vehicle with a mobile body control system loaded thereon;

FIG. 2 is a block diagram of the mobile body control system;

FIG. 3 is an explanatory chart of operation conditions of windows by switches;

FIG. 4 is an explanatory chart of operation conditions of windows by voice;

FIG. 5 is a flowchart of processing for saving window lock information;

FIG. 6 is a first flowchart of window open or close processing according to a voice instruction; and

FIG. 7 is a second flowchart of the window open or close processing according to the voice instruction.

### DETAILED DESCRIPTION OF THE PREFERRED EMBODIMENTS

### 1. Configuration of Vehicle with Mobile Body Control System

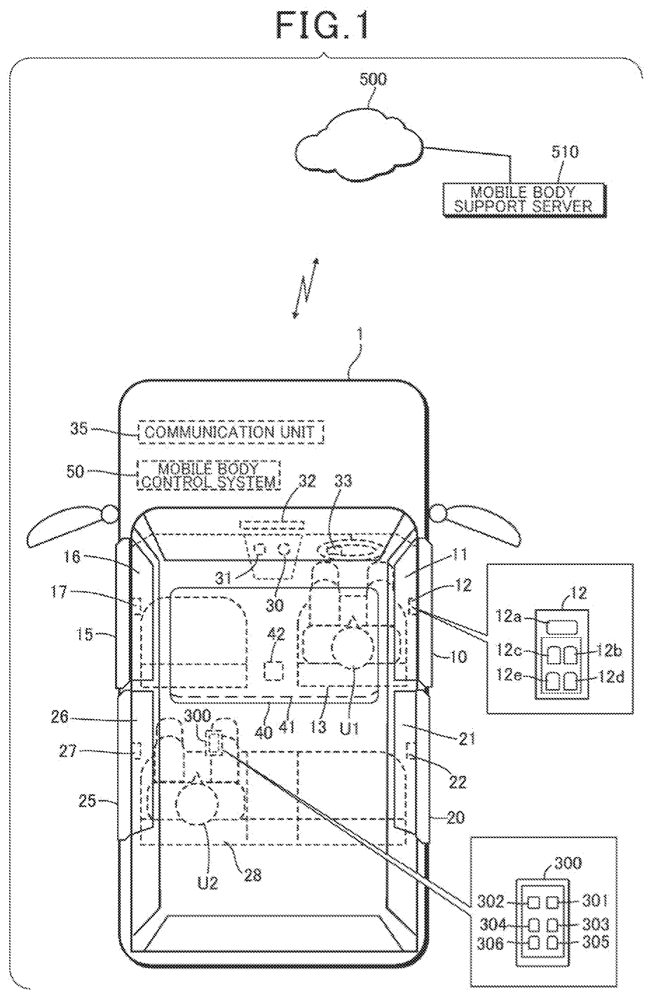

Referring to FIG. 1, the configuration of a vehicle 1 on which a mobile body control system 50 is loaded will be described. The vehicle 1 is a four-wheel vehicle that includes a driver seat door 10, a front seat door 15, a right rear seat door 20, and a left rear seat door 25. The vehicle 1 corresponds to a mobile body of the present disclosure, and the front seat door 15, the right rear seat door 20, and the left rear seat door 25 correspond to another seat of the present disclosure. FIG. 1 illustrates a state were passengers U1 and U2 are on the vehicle 1. The passenger U1 is the driver.

The driver seat door 10 includes a driver seat window 11 and a driver seat door switch 12 for giving an instruction to open or close or the like of the driver seat window 11. The front seat door 15 includes a front seat window 16 and a front seat door switch 17 for giving an instruction to open or close the front seat window 16. The right rear seat door 20 includes a right rear seat window 21 and a right rear seat door switch 22 for giving an instruction to open or close the right rear seat window 21. The left rear seat door 25 includes a left rear seat window 26 and a left rear seat door switch 27 for giving an instruction to open or close the left rear seat window 26.

On a roof of the vehicle 1, provided are a sunroof 40 with a sunshade 41, and a sunroof switch 42 for giving an instruction to open or close the sunroof 40 and the sunshade 41. The driver seat window 11, the front seat window 16, the right rear seat window 21, the left rear seat window 26, and the sunroof 40 are power windows that are opened or closed by an actuator such as an electric motor. Furthermore, the sunshade 41 is also opened or closed by an actuator. Hereinafter, the sunroof 40 and the sunshade 41 are included in the explanations as the windows.

The driver seat door switch 12 includes: a window lock switch 12a for inhibiting operations of the windows 11, 16, 21, 26, and 40; a driver seat window switch 12b for giving an instruction to open or close the driver seat window 11; a front seat window switch 12c for giving an instruction to open or close the front seat window 16; a right rear seat window switch 12d for giving an instruction to open or close the right rear seat window 21; and a left rear seat window switch 12e for giving an instruction to open or close the left rear seat window 26.

Note that the window lock switch 12a may be provided at a place other than the driver seat door 10. For example, the window lock switch 12a may be provided at the front seat door 15, the right rear seat door 20, the left rear seat door 25, or the window lock switch 12a may be displayed on a touch panel 32 as an operation button.

The driver U1 can inhibit open or close operations of the windows by the other passengers by operating the window lock switch 12a to be in a lock instructed state. In a case of FIG. 1, the passenger U2 seated on a left rear seat 28 is inhibited from opening or closing the left rear seat window 26 by operating the left rear seat door switch 27.

Furthermore, the vehicle 1 includes: a microphone 30 that detects the voice of the passengers of the vehicle 1; a speaker 31 that outputs a notification sound or the like; the touch panel 32 with touch switches disposed on a surface of a flat display such as a liquid crystal panel; and a talk switch 33 for starting to accept voice input in accordance with an operation of the driver U1. The touch panel 32 and the speaker 31 correspond to a notification unit of the present disclosure.

Furthermore, the vehicle 1 includes a communication unit 35 (transceiver and receiver) that performs communication with a mobile body support server 510 and the like via a communication network 500. The mobile body support server 510 communicates with the vehicle 1 to support control processing of the vehicle 1 performed by the mobile body control system 50. Furthermore, the communication unit 35 performs communication with a mobile terminal 300 that is used by the passenger U2.

The mobile terminal 300 is a portable communication terminal such as a smartphone, mobile phone, a tablet terminal, or the like, and an app (application) for remotely operating the windows of the vehicle 1 is installed therein. When this app is executed, a sunroof button 301 for giving an instruction to open or close the sunroof 40, a sunshade button 302 for giving an instruction to open or close the sunshade 41, a driver seat window button 303 for giving an instruction to open or close the driver seat window 11, a front seat window button 304 for giving an instruction to open or close the front seat window 16, a right rear seat window button 305 for giving an instruction to open or close the right rear seat window 21, and a left rear seat window button 306 for giving an instruction to open or close the left rear seat window 26 are displayed on a touch panel of the mobile terminal 300.

The passenger U2 can open or close the corresponding window by performing a touch operation of those buttons 301 to 306. For example, when the passenger U2 performs a touch operation on the driver seat window button 303 for giving an open instruction, operation information giving an instruction to open the driver seat window 11 is transmitted to the mobile body control system 50 from the mobile terminal 300, and the processing for opening the driver seat window 11 is executed by the mobile body control system 50. Opening or closing the windows by the operations of the mobile terminal 300 will be described later in “4. Another Embodiment”, and opening or closing the windows by voice operations will be described in the present embodiment.

### 2. Configuration of Mobile Body Control System

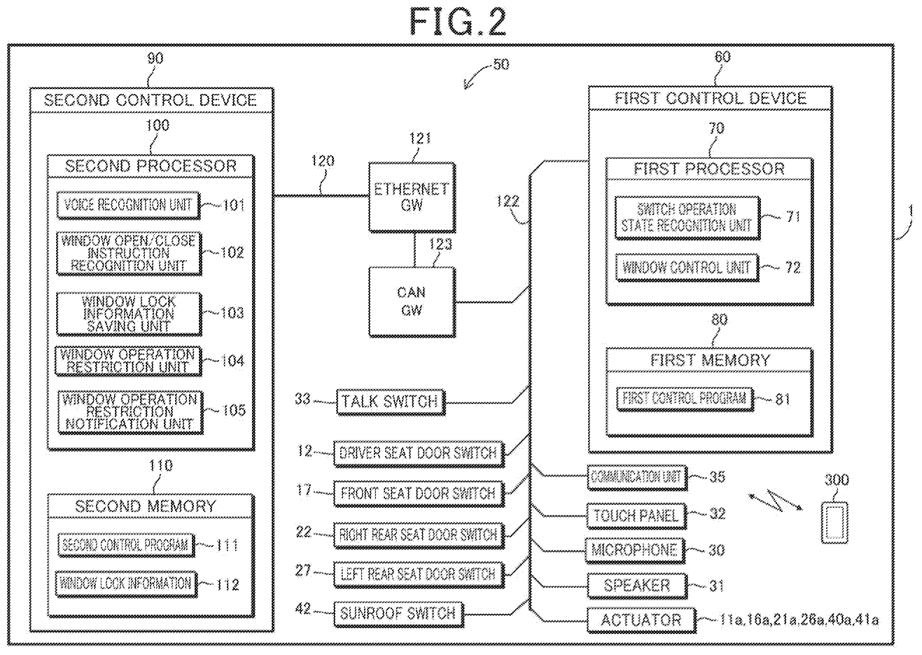

Referring to FIG. 2, the configuration of the mobile body control system 50 will be described. The mobile body control system 50 is configured by including a first control device 60 and a second control device 90. The first control device 60 is connected to a CAN gateway 123 via a CAN (Controller Area Network) 122, and the second control device 90 is connected to an Ethernet gateway 121 via Ethernet (registered trademark) 120. The first control device 60 and the second control device 90 communicate mutually via the Ethernet gateway 121 and the CAN gateway 123. Note that it is also possible to employ a configuration where the first control device 60 and the second control device 90 communicate mutually via other communication specifications than CAN and Ethernet.

The first control device 60 is a control unit that is configured with a first processor 70, a first memory 80, and the like. The first control device 60 is connected to the driver seat door switch 12, the front seat door switch 17, the right rear seat door switch 22, the left rear seat door switch 27, the microphone 30, the speaker 31, the touch panel 32, the talk switch 33, the communication unit 35, and the sunroof switch 42 via the CAN 122. Furthermore, the first control device 60 is connected to an actuator 11a of the driver seat window 11, an actuator 16a of the front seat window 16, an actuator 21a of the right rear seat window 21, an actuator 26a of the left rear seat window 26, an actuator 40a of the sunroof 40, and an actuator 41a of the sunshade 41 via the CAN 122.

The first processor 70 functions as a switch operation state recognition unit 71 and a window control unit 72 by loading and executing a first control program 81 saved in the first memory 80. The first processor 70 corresponds to a computer of the present disclosure, and the first control program 81 corresponds to a mobile body control program of the present disclosure. The first control program 81 may be recorded on a recording medium such as a magnetic disk, an optical disc, or a flash memory, loaded on the first control device from the recording medium, and saved in the first memory 80, or may also be downloaded to the first control device from an external system such as the mobile body support server 510 and saved in the first memory 80.

The processing executed by the switch operation state recognition unit 71 corresponds to a switch operation state recognition step of a mobile body control method according to the present disclosure, and the processing executed by the window control unit 72 corresponds to a window control step of the mobile body control method according to the present disclosure.

The switch operation state recognition unit 71 recognizes the operation states of the driver seat door switch 12 (the window lock switch 12a, the driver seat window switch 12b, the front seat window switch 12c, the right rear seat window switch 12d, the left rear seat window switch 12e), the front seat door switch 17, the sunroof switch 42, the right rear seat door switch 22, and the left rear seat door switch 27 based on switch operation signals input via the CAN 122.

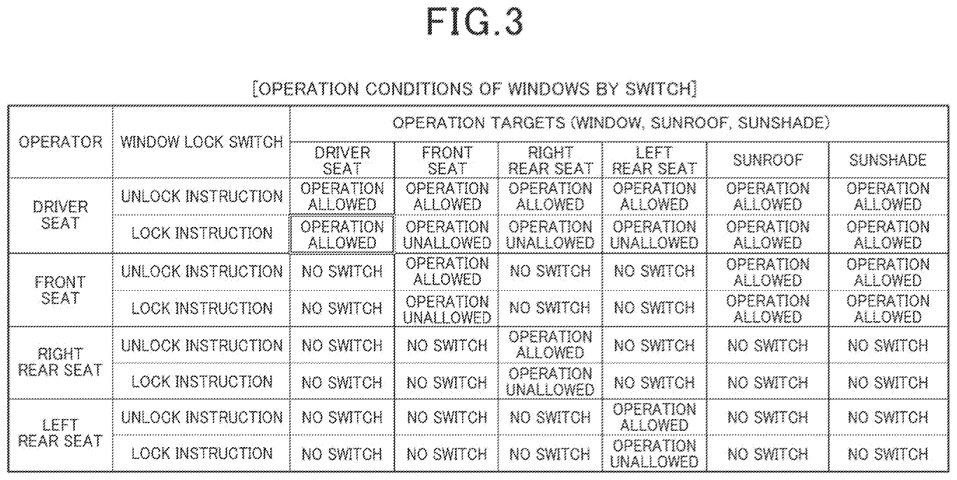

The window control unit 72 operates the actuators 11a, 16a, 21a, 26a, 40a, and 41a under the conditions indicated in FIG. 3 in accordance with the operation states of each of the switches 12, 17, 22, 27, and 42 recognized by the switch operation state recognition unit 71 so as to open or close each of the windows 11, 16, 21, 26, 40, and the sunshade 41.

As indicated in FIG. 3, in a window unlock state where the window lock switch 12a is operated to be in an unlock instructed state, the passengers on each of the seats are capable of performing open or close operations of the windows by the switch as described in following (1-1) to (1-4). (1-1) Driver Capable of performing open or close operations of the driver seat window 11 by the driver seat window switch 12b, open or close operations of the front seat window 16 by the front seat window switch 12c, open or close operations of the right rear seat window 21 by the right rear seat window switch 12d, open or close operations of the left rear seat window 26 by the right rear seat window switch 12e, open or close operations of the sunroof 40 by the sunroof switch 42, and open or close operations of the sunshade 41 by the sunroof switch 42.

(1-2) Passenger on front seat Capable of performing open or close operations of the front seat window 16 by the front seat door switch 17, open or close operations of the sunroof 40 by the sunroof switch 42, and open or close operations of the sunshade 41 by the sunroof switch 42.

(1-3) Passenger on right rear seat Capable of performing open or close operations of the right rear seat window 21 by the right rear seat door switch 22.

(1-4) Passenger on left rear seat Capable of performing open or close operations of the left rear seat window 26 by the left rear seat door switch 27.

Furthermore, in a window lock state where the window lock switch 12a is operated to be in a lock instructed state, only the operations of following (1-5) and (1-6) are possible as indicated in FIG. 3. (1-5) Driver Capable of performing open or close operations of the driver seat window 11 by the driver seat window switch 12b, open or close operations of the sunroof 40 by the sunroof switch 42, and open or close operations of the sunshade 41 by the sunroof switch 42. (1-6) Passenger on front seat Capable of performing open or close operations of the sunroof 40 by the sunroof switch 42, and open or close operations of the sunshade 41 by the sunroof switch.

Furthermore, as will be described later, the window control unit 72 performs open or close operations of each of the windows 11, 16, 21, 26, 40, and the sunshade 41 in accordance with open or close instructions of the windows by the voice of the passengers.

The second control device 90 is a control unit configured with a second processor 100, a second memory 110, and the like. The second processor 100 functions as a voice recognition unit 101, a window open or close instruction recognition unit 102, a window lock information saving unit 103, a window operation restriction unit 104, and a window operation restriction notification unit 105 by loading and executing a second control program 111 saved in the second memory 110.

The second processor 100 corresponds to the computer of the present disclosure, and the second control program 111 corresponds to the mobile body control program of the present disclosure. The second control program 111 may be recorded on a recording medium such as a magnetic disk, an optical disc, or a flash memory, loaded on the second control device 90 from the recording medium, and saved in the second memory 110, or may also be downloaded to the second control device 90 from an external system such as the mobile body support server 510 and saved in the second memory 110.

The processing executed by the window open or close instruction recognition unit 102 corresponds to a window open or close instruction recognition step of the mobile body control method according to the present disclosure, and the processing executed by the window operation restriction unit 104 corresponds to a window operation restriction step of the mobile body control method according to the present disclosure.

The voice recognition unit 101 analyzes the voice detected by the microphone 30 and recognizes the instruction content made by the voice of the passengers. In the embodiment, the voice recognition unit 101 starts to recognize the instruction by the voice upon recognizing a prescribed wakeup word (“Ok, my car”, or the like) or when the talk switch 33 is operated. The window open or close instruction recognition unit 102 recognizes that the voice instruction recognized by the voice recognition unit 101 is instructing to open or close a window.

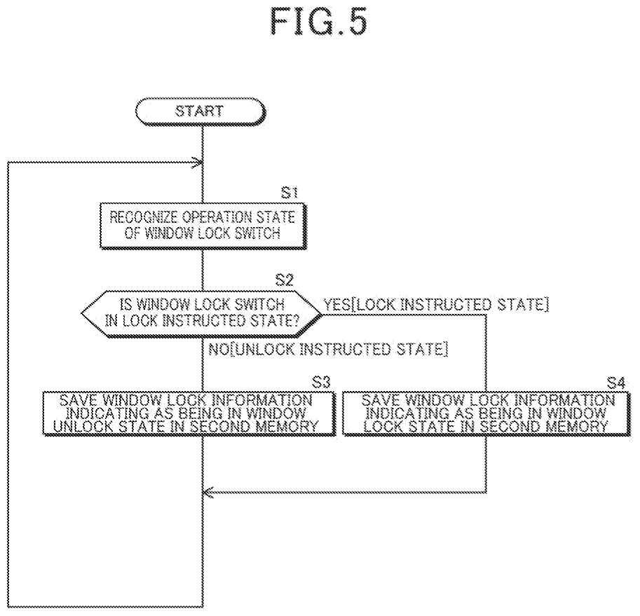

The window lock information saving unit 103 saves, in the second memory 110, window lock information 112 indicating as being in a window lock state or a window unlock state by an operation of the window lock switch 12a through executing the processing of the flowchart illustrated in FIG. 5.

In step S1 of FIG. 5, the window lock information saving unit 103 recognizes the operation state of the window lock switch 12a recognized by the switch operation state recognition unit 71 by having communication between the first control device 60 and the second control device 90. In following step S2, the window lock information saving unit 103 determines whether the window lock switch 12a is in a lock instructed state.

Then, the window lock information saving unit 103 shifts the processing to step S4 when the window lock switch 12a is in a lock instructed stated, and shifts the processing to step S3 when the window lock switch 12a is in an unlock instructed state. In step S4, the window lock information saving unit 103 saves the window lock information 112 indicating as being in a window lock state to the second memory 110. In step S3, the window lock information saving unit 103 saves the window lock information 112 indicating as being in a window unlock state to the second memory 110.

Thereby, when checking whether it is in a window lock state by the second control device 90, it becomes possible to promptly recognize whether it is in a window lock state by referring to the window lock information 112 without performing communication between the first control device 60 and the second control device 90 each time to check the operation state of the window lock switch 12a.

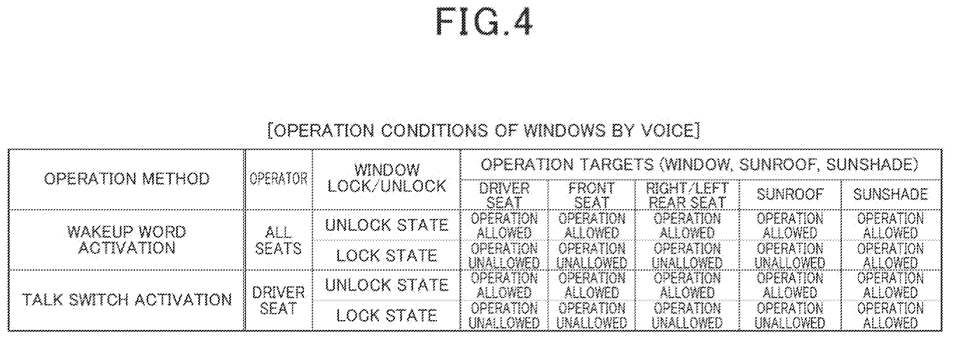

The window operation restriction unit 104 executes the processing (window operation inhibition processing) for restricting the operation of the window by the voice of the passengers as in following (2-1) to (2-2) according to the conditions indicated in FIG. 4.

(2-1. In a Case where Voice Recognition is Activated by Wakeup Word)

When it is in a window unlock state, the passengers on all seats are capable of performing open or close operations of the driver seat window 11, the front seat window 16, the right rear seat window 21, the left rear seat window 26, the sunroof 40, and the sunshade 41.

When it is in a window lock state, the passengers on all seats are capable of performing only the open or close operation of the sunshade 41 but not capable of performing the open or close operations of the driver seat window 11, the front seat window 16, the right rear seat window 21, the left rear seat window 26, and the sunroof 40. Thereby, in accordance with the kinds of the windows, it is possible to give an instruction to open or close the sunshade 41 that is relatively lightweight by a voice operation even in a window lock state, while it is not possible to perform the open or close operations by the voice operation for the driver seat window 11, the front seat window 16, the right rear seat window 21, the left rear seat window 26, and the sunroof 40 other than sunshade 41.

(2-2. In a Case where Voice Recognition is Activated by Talk Switch 33)

When it is in a window unlock state, the driver is capable of performing open or close operations of the driver seat window 11, the front seat window 16, the right rear seat window 21, the left rear seat window 26, the sunroof 40, and the sunshade 41.

When it is in a window lock state, the driver is capable of performing only the open or close operation of the sunshade 41 but not capable of performing the open or close operations of the driver seat window 11, the front seat window 16, the right rear seat window 21, the left rear seat window 26, and the sunroof 40.

In a case where the operation by the voice is restricted by the window operation restriction unit 104 because of the window lock state, the window operation restriction notification unit 105 displays, on the touch panel 32, a screen notifying that the operation by the voice is being inhibited when the voice recognition unit 101 recognizes an open or close instruction by the voice for any of the driver seat window 11, the front seat window 16, the right rear seat window 21, the left rear seat window 26, and the sunroof 40.

### 3. Window Open or Close Processing According to Voice Instruction

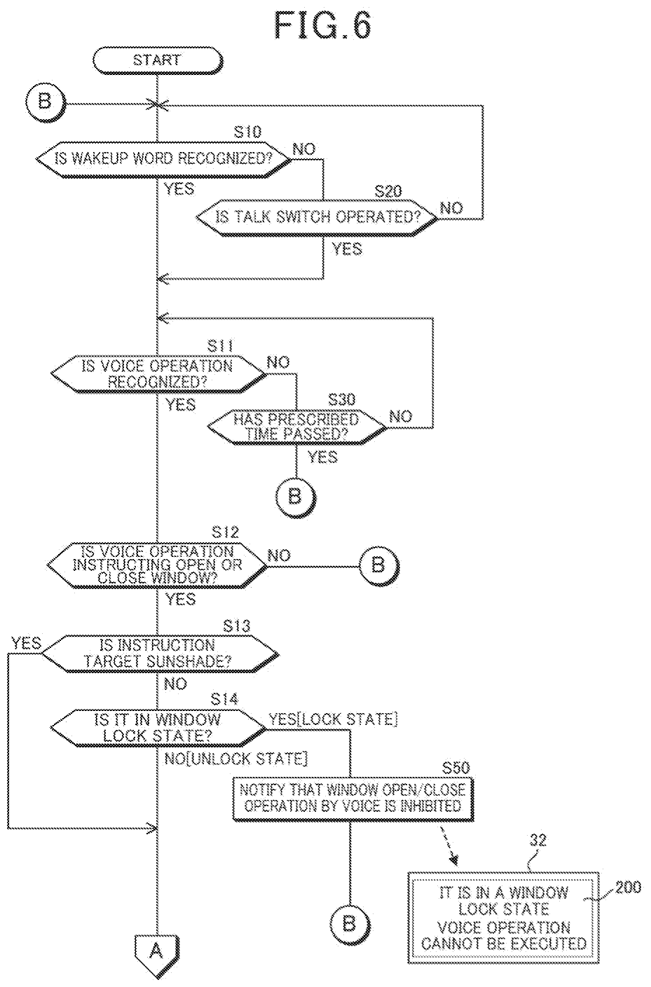

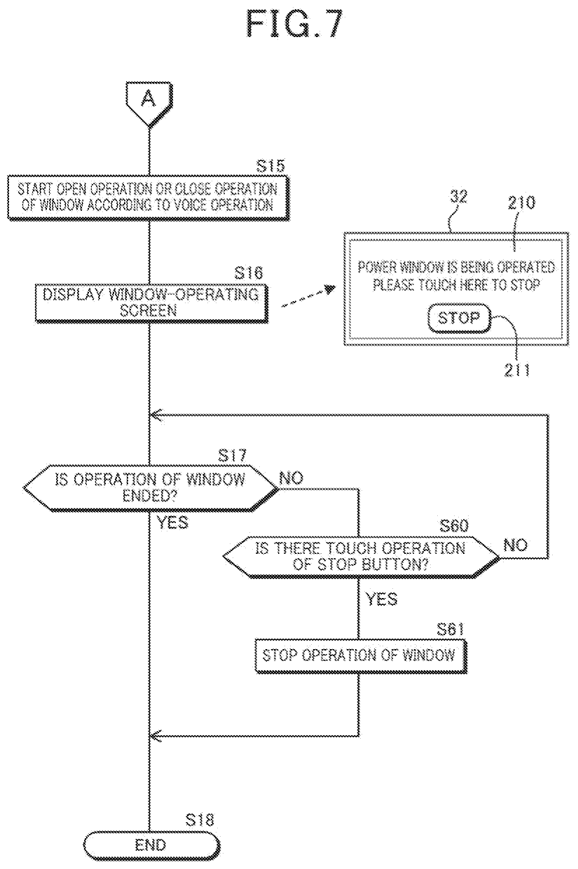

Window open or close processing performed in accordance with a voice instruction will be described according to flowcharts illustrated in FIG. 6 to FIG. 7.

When a wakeup word is recognized in S10 or the talk switch 33 is operated in S20 by looping through steps S10 and S20 of FIG. 6, the voice recognition unit 101 shifts the processing to step S11. When a voice instruction is recognized in step S11 before a prescribed time passes in step S30 by looping through steps S11 and S30, the voice recognition unit 101 shifts the processing to step S12. Furthermore, when a prescribed time has passed in step S30, the voice recognition unit 101 shifts the processing to step S10.

In step S12, the window open or close instruction recognition unit 102 determines whether the voice instruction is an open or close instruction of the window. Then, the window open or close instruction recognition unit 102 shifts the processing to step S13 when the voice instruction is an open or close instruction of the window, and shifts the processing to step S10 when the voice instruction is not an open or close instruction of the window.

In step S13, the window open or close instruction recognition unit 102 determines whether the target of the open or close instruction is the sunshade 41. Then, the window open or close instruction recognition unit 102 shifts the processing to step S15 of FIG. 7 when the target of the open or close instruction is the sunshade 41, and shifts the processing to step S14 of FIG. 7 when the target of the open or close instruction is not the sunshade 41.

In step S14, the window operation restriction unit 104 refers to the window lock information saved in the second memory 110 and recognizes whether it is in a window lock state. Then, when it is in a window lock state, the window operation restriction unit 104 shifts the processing to step S50 where a screen 200 notifying that it is in a window lock state and that the operation of the windows by the voice is not possible is displayed on the touch panel 32, and then shifts the processing to step S10.

In the meantime, when it is not a window lock state (in a window unlock state), the window operation restriction unit 104 shifts the processing to step S15 of FIG. 7. In this case, operations of the windows by the voice are not restricted. In step S15, the window control unit 72 executes an open operation or a close operation of the window in accordance with a voice instruction.

The window control unit 72 recognizes the window of the operation target and the operation direction (open operation or close operation) based on an execution command corresponding to the voice instruction transmitted to the first control device 60 from the second control device 90. For example, when the voice instruction is “open the window of the front seat”, the window control unit 72 operates the actuator 16a of the front seat window 16 to the opening direction so as to open the front seat window 16.

In following step S16, the window operation restriction notification unit 105 displays, on the touch panel 32, a window-operating screen 210 notifying that the window is being operated. On the window operating screen 210, a window stop button 211 for instructing to stop the operating window is displayed. The window stop button 211 corresponds to a switch provided to the mobile body of the present disclosure.

Following step S17 and steps S60 to S61 are the processing (window operation stop processing) performed by the window operation restriction unit 104. By looping through step S17 and step S60, the window operation restriction unit 104 determines in step S17 whether the operation of the window is ended, and determines in step S60 whether the window stop button 211 is operated.

Then, when the operation of the window is ended, the window operation restriction unit 104 shifts the processing from step S17 to step S18. Furthermore, when the window stop button 211 is operated, the window operation restriction unit 104 shifts the processing from step S60 to step S61 to stop the operating window, and then shifts the processing to step S18.

Note that the operating window may also be stopped in accordance with the voice instruction, when a switch other than the window stop button provided to the vehicle 1 is operated. For example, the window operation restriction unit 104 may stop the operating window, when any of the driver seat window switch 12b, the front seat window switch 12c, the right rear seat window switch 12d, and the left rear seat window switch 12e of the driver seat door switch 12, the front seat door switch 17, the right rear seat door switch 22, and the left rear seat door switch 27 is operated.

### 4. Another Embodiment

In the embodiment above, described is the processing of a case where the window open or close instruction recognition unit 102 recognizes the voice operation giving an open or close instruction of the window. As another embodiment, the window open or close instruction recognition unit 102 executes the same processing as that of the case where the voice operation is recognized, also when the buttons 301 to 306 for operating respective windows displayed on the touch panel of the mobile terminal 300 are operated, as described above by referring to FIG. 1.

That is, the window open or close instruction recognition unit 102 executes the processing where the voice operation in the flowcharts of FIG. 6 to FIG. 7 is replaced with the operations of the buttons 301 to 306 displayed on the touch panel of the mobile terminal 300. Specifically, the processing of steps S10, S11, S12, S20, and S30 in FIG. 6 is “processing of determining which of the buttons 301 to 306 is operated”, and step S50 is the processing of “notifying that the open or close operation of the window via the mobile terminal is inhibited”. Furthermore, step S15 of FIG. 7 is the processing of “starting an open operation or a close operation of the window in accordance with the button operation”. Moreover, the operation conditions of the windows by the voice indicated in FIG. 4 are also the same in the case of the operations of the buttons 301 to 306 of the mobile terminal 300.

While the four-wheel vehicle 1 is described in the embodiment above as the mobile body of the present disclosure, the mobile body of the present disclosure may be any mobile body capable of giving an open or close instruction of the windows by the voice, and may also be other kinds of mobile bodies such as a two-wheel vehicle, a three-wheel vehicle, a flight vehicle, a boat, and the like.

While the configuration where the mobile body control system 50 is provided to the vehicle 1 is described as an example in the embodiment above, it is also possible to employ a configuration where a part of or a whole part of the configuration of the mobile body control system 50 is provided to the mobile body support server 510. For example, the voice recognition unit 101 may be provided to the mobile body support server 510. In this case, voice data is transmitted to the mobile body support server 510 from the vehicle 1, and the mobile body support server executes processing for analyzing the voice data. Then, voice recognition data indicating the analysis result of the voice data is transmitted to the vehicle 1 from the mobile body support server 510.

In the embodiment described above, the mobile body control system 50 is configured with the first control device 60 and the second control device 90 communicating mutually, and the window lock information 112 is saved in the second memory 110 by the window lock information saving unit 103. As another embodiment, the mobile body control system 50 may be configured with a single control device, so that there is no communication required between the control devices in accordance with a voice operation, and that the window lock information saving unit 103 may be omitted.

While the screen 200 notifying that the operation of the windows by the voice is restricted is displayed on the touch panel 32 by the window operation restriction notification unit 105 in the embodiment described above, it is also possible to output a notification sound (voice guidance, buzzer sound, or the like) from the speaker 31. Furthermore, it is also possible to notify that the operation of the windows by the voice is restricted by performing both display on the touch panel 32 and output of the notification sound from the speaker 31. This is also the same for the case of operations of the buttons 301 to 306 of the mobile terminal 300.

Note that FIG. 2 is a schematic diagram where the configuration of the mobile body control system 50 is sectioned according to the main processing content to facilitate understanding of the present invention, but the configuration of the mobile body control system 50 may be sectioned according to other perspectives. Furthermore, the processing of each of structural elements may be executed by a single hardware unit or may be executed by a plurality of hardware units. Moreover, the processing by each of the structural elements indicated in FIG. 5 to FIG. 7 may be executed by a single program or may be executed by a plurality of programs.

### 5. Configuration Supported by Aforementioned Embodiments

The embodiments described above are specific examples of the following configurations.

(Configuration 1) A mobile body control system including: a window open or close instruction recognition unit that recognizes an open or close instruction of a window provided to a mobile body in accordance with a voice operation or an operation of a mobile terminal performed by a passenger on the mobile body; a window control unit that executes a window open or close control for opening or closing the window according to the instruction, when the open or close instruction of the window is recognized by the window open or close instruction recognition unit; and a window operation restriction unit that executes at least one of window operation inhibition processing for inhibiting execution of the window open or close control by the window operation restriction unit in accordance with an operation of a switch provided to the mobile body, and window operation stop processing for stopping the window that is being operated by the window open or close control in accordance with an operation of the switch.

According to the mobile body control system of the configuration 1, it is possible to prevent the open or close operation of the window from being performed against the intention of passengers when a plurality of passengers are on the mobile body, by executing at least one of the window operation inhibition processing for inhibiting execution of the window open or close control, and the window operation stop processing for stopping the window that is being operated by the window open or close control in accordance with an operation of the switch provided to the mobile body.

(Configuration 2) The mobile body control system according to the configuration 1, in which the switch is a window lock switch for inhibiting an open or close operation of the window, and the window operation restriction unit executes the window operation inhibition processing, when turned into a window lock state where the open or close operation of the window is inhibited by an operation of the window lock switch.

According to the mobile body control system of the configuration 2, it is possible to inhibit the open or close operation of the window by the voice operation of the passenger or the operation of the mobile terminal by turning to a window lock state through the operation of the window lock switch provided to the mobile body.

(Configuration 3) The mobile body control system according to the configuration 2 includes a window operation restriction notification unit that notifies, by a notification unit provided to the mobile body, that the open or close operation of the window is inhibited, when the open or close instruction of the window is recognized by the window open or close instruction recognition unit in the window lock state.

According to the mobile body control system of the configuration 3, it is possible to notify, by the notification unit, the passenger who is about to give the open or close instruction of the window by the voice operation or the operation of the mobile terminal to recognize that the open or close operation of the window is inhibited.

(Configuration 4) The mobile body control system according to the configuration 2 or the configuration 3, in which the mobile body has, as the window, a driver seat window corresponding to a driver seat and another seat window corresponding to another seat other than the driver seat. The mobile body further includes: a driver seat window switch for giving an instruction to open or close the driver seat window; and another seat window switch for giving an instruction to open or close the another seat window. In the window lock state, the window control unit: inhibits accepting the instruction to open or close the another seat window by an operation of the another seat window switch; and accepts the instruction to open or close the driver seat window by an operation of the driver seat window switch.

According to the mobile body control system of the configuration 4, in the window lock state, different restriction conditions are set for the voice operation and the operation of the driver seat window switch. That is, while operations of all windows including the driver seat window are inhibited for the voice operation, the operation of the driver seat window by the driver seat window switch is possible. As described, by allowing the open or close operation of the driver seat window by the operation of the driver seat window switch even in the window lock state, the driver can perform an enter or exit operations at a parking gate, receive items at a drive-through store, and the like for the convenience.

(Configuration 5) The mobile body control system according to any one of the configuration 2 to the configuration 4 includes: a first control device and a second control device communicating mutually; a switch operation state recognition unit that is provided to the first control device and recognizes an operation state of the window lock switch; and a window lock information saving unit that, upon recognizing by the switch operation state recognition unit through having communication between the first control device and the second control device that a setting operation of the window lock state is performed via the window lock switch, saves window lock information indicating as being in the window lock state to a storage unit that is provided to the second control device. The window operation restriction unit refers to the window lock information saved in the storage unit to recognize as being in the window lock state.

According to the mobile body control system of the configuration 5, the window operation restriction unit can recognize as being in the window lock state by referring to the window lock information saved in the storage unit without performing communication between the first control device and the second control device. Thereby, the window operation restriction unit can promptly recognize as being in the window lock state and execute the window operation inhibition processing.

(Configuration 6) The mobile body control system according to any one of the configuration 1 to the configuration 5, which includes a voice recognition unit that executes recognition processing of the voice operation, after recognizing a voice of a prescribed wakeup word.

According to the mobile body control system of the configuration 6, in a mode that accepts the open or close instruction of the window by the voice on condition that the voice of the wakeup word is recognized, it is possible to prevent the window from being opened or closed against the intention of the passenger.

The mobile body control system according to any one of the configuration 1 to the configuration 6, in which, when the window is being operated by the window open or close control, the window operation restriction unit executes the window operation stop processing when a stop button displayed on a touch panel provided to the mobile body or an open or close switch of the window provided to the mobile body is operated as the operation of the switch.

According to the mobile body control system of the configuration 7, the passenger can stop the operating window by the operation of the touch panel provided to the mobile body or the operation of the open or close switch of the window.

(Configuration 8) The mobile body control system according to any one of the configuration 1 to the configuration 7, in which the mobile body includes a plurality of the windows of different kinds, and the window operation restriction unit sets the window to be an execution target of the window operation inhibition processing in accordance with the kinds of the windows.

According to the mobile body control system of the configuration 8, in a case where different kinds of windows such as a sunroof and a sunshade are provided to the mobile body, for example, it is possible to set the sunroof that is heavy to some extent and desirable to avoid contact with the passenger to be the execution target of the window operation inhibition processing, and to set the sunshade that is light to be out of the execution target of the window operation inhibition processing.

(Configuration 9) A mobile body control method executed by a computer, and the method includes: a window open or close instruction recognition step of recognizing an open or close instruction of a window provided to a mobile body in accordance with a voice operation or an operation of a mobile terminal performed by a passenger on the mobile body; a window control step of executing a window open or close control for opening or closing the window according to the instruction, when the open or close instruction of the window is recognized by the window open or close instruction recognition step; and a window operation restriction step of executing at least one of window operation inhibition processing for inhibiting execution of the window open or close control performed by the window control step in accordance with an operation of a switch provided to the mobile body, and window operation stop processing for stopping the window that is being operated by the window open or close control in accordance with an operation of the switch.

Through executing the mobile body control method of the configuration 9 by the computer, it is possible to acquire the same operation effect as that of the mobile body control system of the configuration 1.

(Configuration 10) A non-transitory computer readable recording medium including a mobile body control program to be executed by a processor of a computer provided to a mobile body control system for controlling a mobile body, in which the processor executes the mobile body control program to: recognize an open or close instruction of a window provided to the mobile body in accordance with a voice operation or an operation of a mobile terminal performed by a passenger on the mobile body; execute a window open or close control for opening or closing the window according to the instruction, when the open or close instruction of the window is recognized; and execute at least one of window operation inhibition processing for inhibiting execution of the window open or close control in accordance with an operation of a switch provided to the mobile body, and window operation stop processing for stopping the window that is being operated by the window open or close control in accordance with an operation of the switch.

Through executing the mobile body control program recorded on the recording medium of the configuration 10 by the computer, it is possible to implement the configuration of the mobile body control system according to the configuration 1.

### REFERENCE SIGNS LIST

1 Vehicle (mobile body)
10 Driver seat door
11 Driver seat window
12 Driver seat door switch
12a Window lock switch
12b Driver seat window switch
12c Front seat window switch
12d Right rear seat window switch
12e Left rear seat window switch
15 Front seat door
16 Front seat window
17 Front seat door switch
20 Right rear seat door
21 Right rear seat window
22 Right rear seat door switch
25 Left rear seat door
26 Left rear seat window
27 Left rear seat door switch
30 Microphone
31 Speaker (notification unit)
32 Touch panel (notification unit)
33 Talk switch
35 Communication unit
40 Sunroof
41 Sunshade
42 Sunroof switch
50 Mobile body control system
60 First control device
70 First processor
71 Switch operation state recognition unit
72 Window control unit
80 First memory
81 First control program
90 Second control device
100 Second processor
101 Voice recognition unit
102 Window open or close instruction recognition unit
103 Window lock information saving unit
104 Window operation restriction unit
105 Window operation restriction notification unit
110 Second memory
111 Second control program
112 Window lock information

What is claimed is:

1. A mobile body control system comprising a processor, wherein
the processor:
recognizes an open or close instruction of a window provided to a mobile body in accordance with a voice operation or an operation of a mobile terminal performed by a passenger on the mobile body;
executes a window open or close control for opening or closing the window according to the instruction, when the open or close instruction of the window is recognized; and
executes at least one of window operation inhibition processing for inhibiting execution of the window open or close control in accordance with an operation of a switch provided to the mobile body, and window operation stop processing for stopping the window that is being operated by the window open or close control in accordance with an operation of the switch.

2. The mobile body control system according to claim 1, wherein
the switch is a window lock switch for inhibiting an open or close operation of the window, and
the processor executes the window operation inhibition processing, when turned into a window lock state where the open or close operation of the window is inhibited by an operation of the window lock switch.

3. The mobile body control system according to claim 2, wherein, in the window lock state, the processor,
when the open or close instruction of the window is recognized, displays, on a display provided to the mobile body, that the open or close operation of the window is inhibited, or make a notification by outputting a notification sound from a speaker provided to the mobile body.

4. The mobile body control system according to claim 2, wherein
the mobile body has, as the window, a driver seat window corresponding to a driver seat and another seat window corresponding to another seat other than the driver seat, the mobile body further comprising: a driver seat window switch for giving an instruction to open or close the driver seat window; and another seat window switch for giving an instruction to open or close the another seat window, and
in the window lock state, the processor: inhibits accepting the instruction to open or close the another seat window by an operation of the another seat window switch; and accepts the instruction to open or close the driver seat window by an operation of the driver seat window switch.

5. The mobile body control system according to claim 2, wherein
the processor is configured with a first processor and a second processor,
a first control device comprising the first processor and a first memory communicates mutually with a second control device comprising the second processor and a second memory,
the first processor:
recognizes an operation state of the window lock switch; and
upon recognizing through having communication between the first control device and the second control device that a setting operation of the window lock state is performed via the window lock switch, saves window lock information indicating as being in the window lock state to the second memory that is provided to the second control device, and
the second processor refers to the window lock information saved in the second memory to recognize as being in the window lock state.

6. The mobile body control system according to claim 5, wherein the second processor executes recognition processing of the voice operation, after recognizing a voice of a prescribed wakeup word.

7. The mobile body control system according to claim 5, wherein, when the window is being operated by the window open or close control, the second processor executes the window operation stop processing when a stop button displayed on a touch panel provided to the mobile body or an open or close switch of the window provided to the mobile body is operated as the operation of the switch.

8. The mobile body control system according to claim 5, wherein
the mobile body comprises a plurality of the windows of different kinds, and
the second processor sets the window to be an execution target of the window operation inhibition processing in accordance with the kinds of the windows.

9. A mobile body control method executed by a computer, wherein the method:
recognizes an open or close instruction of a window provided to a mobile body in accordance with a voice operation or an operation of a mobile terminal performed by a passenger on the mobile body;
executes a window open or close control for opening or closing the window according to the instruction, when the open or close instruction of the window is recognized; and
executes at least one of window operation inhibition processing for inhibiting execution of the window open or close control performed in accordance with an operation of a switch provided to the mobile body, and window operation stop processing for stopping the window that is being operated by the window open or close control in accordance with an operation of the switch.

10. A non-transitory computer readable recording medium comprising a mobile body control program to be executed by a processor of a computer provided to a mobile body control system for controlling a mobile body, wherein
the processor executes the mobile body control program to:
recognize an open or close instruction of a window provided to the mobile body in accordance with a voice operation or an operation of a mobile terminal performed by a passenger on the mobile body;
execute a window open or close control for opening or closing the window according to the instruction, when the open or close instruction of the window is recognized; and
execute at least one of window operation inhibition processing for inhibiting execution of the window open or close control in accordance with an operation of a switch provided to the mobile body, and window operation stop processing for stopping the window that is being operated by the window open or close control in accordance with an operation of the switch.
